(19) United States
(12) Patent Application Publication
(10) Pub. No.: US 2024/0398103 A1
(43) Pub. Date: Dec. 5, 2024

(54) MASCARA BRUSH

(71) Applicant: LVMH RECHERCHE, Saint-Jean-De-Braye (FR)

(72) Inventor: Marc CHEVALIER, Saint-Jean-De-Braye (FR)

(73) Assignee: LVMH RECHERCHE, Saint-Jean-De-Braye (FR)

(21) Appl. No.: 18/713,840

(22) PCT Filed: Nov. 22, 2022
(86) PCT No.: PCT/FR2022/052156

§ 371 Date: May 28, 2024

(30) Foreign Application Priority Data
Nov. 26, 2021 (FR) FR2112582

(51) Int. Cl. A46B 9/02; A45D 40/26; A46B 5/00; A46D 3/00; B33Y 80/00

(52) U.S. Cl. CPC A46B 9/021; A45D 40/262; A46B 5/0095; A46B 9/026; A46D 3/00; B33Y 80/00; A46B 2200/1053

(57) ABSTRACT

A mascara brush including a hollow envelope and at least one applicator element support extending from the envelope in cantilever, in which at least one applicator element support carries at least one applicator element at a free end of the at least one applicator element support.

### TECHNICAL FIELD

This summary relates to a mascara brush, and more specifically a structure of a mascara brush. Such a mascara brush can in particular have an application in the field of cosmetics.

### PRIOR ART

A mascara brush is used to collect a formula contained in a bottle, then apply it to the eyelashes of a user.

To simplify the use of a mascara brush, it would be advantageous to be able to provide a mascara brush allowing better application of formula to the eyelashes.

### SUMMARY OF THE INVENTION

For this purpose, this summary relates to a mascara brush comprising a hollow envelope and at least one applicator element support extending from the envelope in cantilever, in which at least one applicator element support carries at least one applicator element at a free end of the at least one applicator element support.

The term “applicator element” should be understood to mean a formula applicator element, for example in the form of a hair, a bristle, a piece of foam, etc.

The term “hollow envelope” should be understood to mean an envelope, an inner part of which (also known as the “inside”) is at least partly hollowed out, preferably totally devoid of material.

The term “extend in cantilever” refers to the fact that the applicator element support overhangs the envelope or even the end by which it is retained on the envelope.

In this summary, the main axis of the brush is called the main axis. The axial direction corresponds to the direction of the main axis and a radial direction is a direction perpendicular to this axis and intersecting this axis. Similarly, an axial plane is a plane containing the main axis and a radial plane is a plane perpendicular to this axis. A circumference extends as a circle belonging to a radial plane and the center of which belongs to the main axis. A tangential or circumferential direction is a direction tangent to a circumference; it is perpendicular to the axis but does not pass through the axis. A tangential or circumferential plane is a plane strictly parallel to the axis, i.e. not intersecting the axis and not containing the axis.

It will be understood that in a conventional use of a mascara brush, the axial direction of extension of the brush substantially corresponds to a direction of distribution of the eyelashes over the eyelid. Thus, an eyelash extends in a plane substantially equivalent to a radial plane.

In such a brush, the cantilevered mounting of the applicator element support provides a certain flexibility of the applicator element support with respect to the envelope. In this way the applicator element support makes it possible to simplify the following of an eyelash when applying formula, thus improving the comfort of use and effectiveness of application of formula.

In such a brush, the flexibility of the applicator element support also permits an oscillating to-and-fro movement of the applicator element support having an effect of pumping of the product from the inside of the hollow envelope toward the applicator elements. This pumping effect makes it possible to ensure that a sufficient quantity of formula is available to be applied to the eyelashes.

In certain embodiments, the envelope is made as a single part with the at least one applicator element support.

The term “made as a single part” should be understood to mean formed as a single, same part without requiring any assembly. In other words the term “made as a single part” should be understood to mean formed as a single, same self-contained part.

Such a structure makes it possible to reduce the number of parts needed to manufacture the brush. In particular, such a structure is particularly suitable for manufacturing by additive manufacturing methods.

In addition, such a structure ensures better control of the mechanical resistance of the cantilevered applicator element support.

In certain embodiments, the at least one applicator element is made as a single part with the applicator element support.

Such a structure makes it possible to reduce the number of parts needed to manufacture the brush while guaranteeing a robust attachment between the applicator element and the applicator element support. In particular, such a structure is particularly suitable for manufacturing by additive manufacturing methods.

The position of the applicator element at a free end of the applicator element support is a position from among the positions at which the displacement of the applicator element support has the greatest amplitude, i.e. from among the positions at which an applicator element carried by the applicator element support will be able to follow an eyelash as well as possible when applying formula.

In certain embodiments, the at least one applicator element support has a transverse section between 0.25 mm² and 5 mm², preferably between 1 mm² and 2 mm². A transverse direction is a direction transverse to the direction along which the applicator element support extends in cantilever.

Such a transverse section makes it possible ensure good flexibility of the applicator element support along with good mechanical resistance, to ensure following of the eyelash without the risk of damaging the eyelash. Such a transverse section is also suitable for the use of additive manufacturing methods.

In certain embodiments, the at least one applicator element support extends in cantilever from the envelope over a distance between 0.25 mm and 5 mm, preferably between 1 mm and 3 mm.

Such a distance makes it possible to ensure a great enough amplitude of displacement for effective following of the eyelash when applying formula.

In certain embodiments, the applicator element support is connected to the envelope, forming a taper.

In other words, the taper forms a connecting portion between the envelope and the rest of the applicator element support. The taper increases the flexibility of the support. The widest portion of the applicator element support has a surface for receiving an applicator element and forms the cantilever of the applicator element support.

In certain embodiments, the at least one applicator element support extends substantially along a tangential plane of the brush. Thus, the applicator element support can deform along a radial direction, corresponding to the direction of extension of an eyelash when applying formula.

In certain embodiments, the brush comprises at least one support pattern formed by a pair of applicator element supports extending in one and the same direction and in opposite orientations.

The deformation of the applicator element supports in opposite orientations causes an offset between the applicator elements when applying the mascara, enabling it to be applied more evenly.

In certain embodiments, the applicator element supports extend substantially along a circumferential and/or axial direction.

In certain embodiments, the applicator element supports extend substantially along a circumferential and/or axial direction, preferably one with respect to the other. More generally, the applicator element supports extend substantially along a circumferential and/or axial direction even if they do not belong to a support pattern.

Such a structure promotes a deformation along a radial direction of the applicator element supports such as to improve the following of an eyelash when applying formula.

In certain embodiments, a plurality of support patterns are formed on a circumferential contour of the brush. Alternatively or complementarily, a plurality of support patterns are formed along the main axis of the brush.

The invention also relates to a method for manufacturing a mascara brush according to this summary, comprising at least one step of manufacturing by additive method.

An additive manufacturing method is particularly suitable for producing complex structures of the brush of this disclosure, particularly for the manufacturing of the hollow envelope and the cantilevered structure of the applicator element support.

The invention also relates to a brush comprising a stick and a mascara brush according to this summary.

### BRIEF DESCRIPTION OF THE DRAWINGS

FIG. 1 is a perspective view of a brush according to a first embodiment.

FIG. 2 is a lateral view of a brush according to the first embodiment.

FIG. 3 is a view of the brush along the section plane III-III of FIG. 2.

FIG. 4 is a magnification of the view IV of FIG. 2.

FIG. 5 is a schematic view of a support pattern of the first embodiment.

### DESCRIPTION OF THE EMBODIMENTS

This invention will be described with reference to specific exemplary embodiments. However, it is obvious that modifications and changes may be made to these examples without departing from the general scope of the invention as defined by the claims. In particular, individual features of the different embodiments illustrated/mentioned may be combined into additional embodiments. Consequently, the description and drawings must be considered in an illustrative sense rather than a restrictive one.

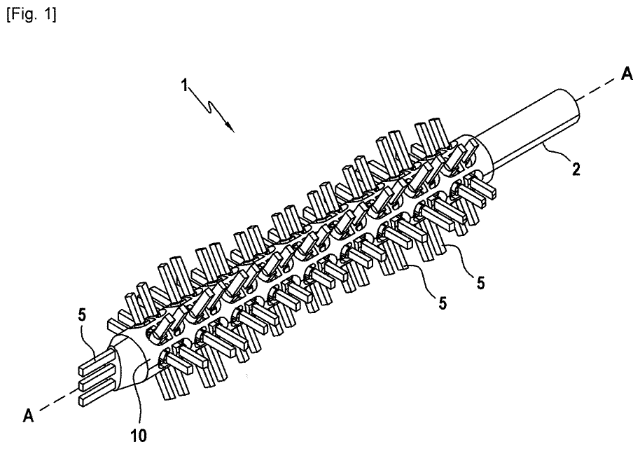

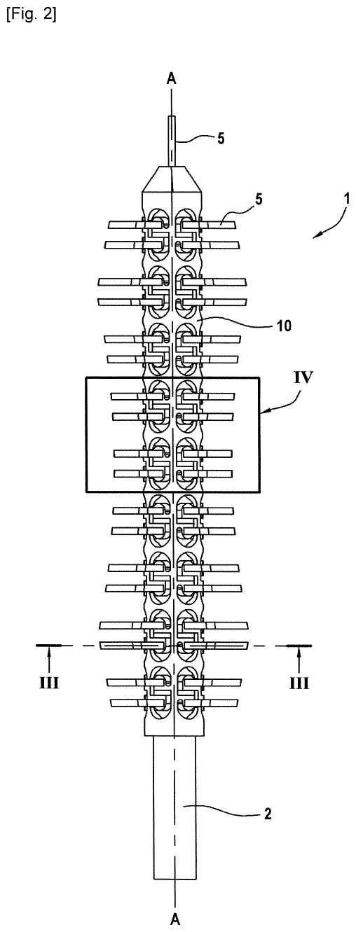

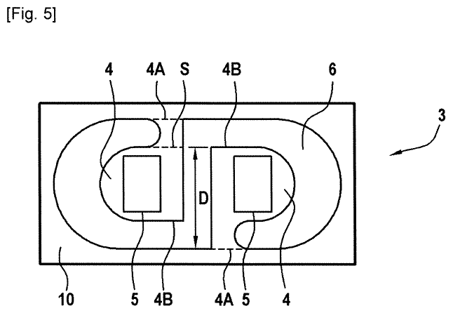

The general structure of the brush will be described in relation to FIGS. 1 to 3. The brush and the applicator element supports will be described in relation to FIGS. 4 and 5.

Hereinafter, unless there is a contrary mention of a deformation, the brush 1 will be described at rest.

The brush 1 extends substantially along a main axis A.

One end of the brush 1 is free, and corresponds to an end by which the brush enters a bottle to collect formula. Another end is connected to a brush support 2, which can be assembled on a stick in such a way as to form a mascara applicator.

The brush 1 comprises a hollow envelope 10.

The envelope 10 extends along the main axis A, over a distance between 8 and 45 mm, preferably between 25 mm and 40 mm, preferably equal to 30 mm.

Here the envelope 10 has the shape of a hollow revolution cylinder centered on the main axis A.

However, the envelope 10 can have various shapes centered on the main axis A. For example, the envelope 10 can have any kind of cylinder shape, frustoconical, pyramidal or frustopyramidal shape. Thus, the envelope 10 can for example have an outer contour of polygonal shape (triangle, quadrilateral, rectangle, hexagon, octagon etc.) optionally regular, or else circular or ellipsoidal.

The brush 1 comprises applicator elements 5. The envelope 10, surrounded by the applicator elements 5, forms the core of the brush 1. The applicator elements 5 extend along a direction radially outward from the envelope 10. The brush 1 can also comprise one or more applicator elements 5 extending axially, carried by a free end of the envelope 10.

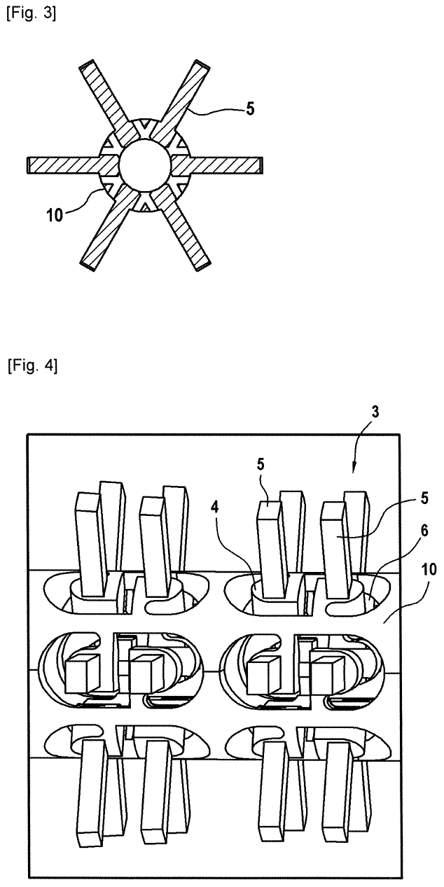

As shown in FIG. 3, corresponding to a section view along a radial plane, the brush 1 may have, in the section plane III-III, for example six applicator elements 5 evenly distributed over a circumferential contour of the brush 1.

In general, the pattern of six applicator elements 5 can be repeated on the brush 1 in an axial direction.

However, the brush 1 may have other numbers and/or other distributions of applicator elements 5, particularly those described hereinafter in relation to the applicator element support patterns of FIGS. 4 and 5.

As shown on the magnification of FIG. 4 and on the schematic view of FIG. 5, the brush 1 comprises at least one applicator element support 4, in this case and with no loss of generality, a plurality of applicator element supports 4.

The applicator element supports 4 can each carry at least one applicator element 5.

The applicator element supports 4 are formed as a single part with the envelope 10, and extend in cantilever from the envelope 10.

The direction along which an applicator element support 4 extends in cantilever from the envelope 10 can be different from the direction along which an applicator element 5 carried by said applicator element support 4 extends.

In this case, the angle formed between the direction along which the applicator element support 4 extends in cantilever from the envelope 10 and the direction along which the applicator element 5 carried by said applicator element support 4 extends can be greater than 45°, preferably greater than 60°, preferably equal to 90°.

The applicator element supports 4 have an end, the so-called fixed end 4A, shown in dashed lines in FIG. 5, forming a connection with the envelope 10, and a free end 4B. It is possible for the free end 4B to only be connected to the envelope 10 via the fixed end 4A.

The applicator element supports 4 are thus formed in a window of the envelope 10, i.e. a part of the envelope 10 characterized by an absence of any material other than the material of the applicator element supports 4, and the applicator element supports 4 are connected to a border of the window of the envelope 10 by the fixed end 4A.

Due to the presence of the applicator element supports 4 in the window of the envelope 10, an interstice 6 is formed around the applicator element supports 4. An interstice 6 corresponds to a part of the window of the envelope 10 not having any applicator element supports 4, generally at the direct periphery of the applicator element supports 4.

In other words, the brush 1 comprises an envelope 10, hollow, in which interstices 6 are fashioned. The interstices 6 traverse the wall of the envelope 10 and so form cut-outs, or slits. Each interstice 6 follows an open contour and therefore delimits, in its inside, one or more applicator element supports 4 attached to the envelope 10. As shown in detail in FIG. 5, a band of material connects the envelope 10 and an applicator element support 4. In particular, the band of material connects two portions locally closest to the interstice 6 and forms the fixed end 4A of an applicator element support 4; in the manner of a material bridge, the fixed end 4A connects the envelope 10 to the rest of the applicator element support 4.

Thus, in this particular case, the applicator element supports 4 are retained on the envelope 10 by the fixed end 4A, and overhang the fixed end 4A. The direction along which an applicator element support 4 extends in cantilever can be defined as the direction along which the applicator element support 4 overhangs the fixed end 4A.

For example, the direction along which an applicator element support 4 overhangs the fixed end 4A can be defined as the direction connecting the fixed end 4A and the free end 4B.

If the applicator element support 4 is curved (for example non-planar), the direction along which an applicator element support 4 extends can be defined along the curvature of the applicator element support 4 and be a curved direction.

As a complement to, or replacement of a curved direction, it will be understood that the direction can also be rectilinear and/or curved, where applicable piecewise.

In addition to extending in cantilever along a direction between the fixed end 4A and the free end 4B, an applicator element support 4 can optionally and secondarily extend in cantilever along another direction from a portion specific to the applicator element support 4.

For example, the applicator element support 4 of this embodiment extends in cantilever in a way that overhangs the fixed end 4A in a circumferential direction, and extends in cantilever secondarily from a portion between the fixed end 4A and the free end 4B in an axial direction.

The fact of extending in cantilever along a curved direction or extending in cantilever along two directions makes it possible, for example, to add an additional degree of deformation mobility to the applicator element support 4.

The direction along which an applicator element support 4 extends in cantilever from a portion of said applicator element support 4 itself is different from the direction along which an applicator element 5 carried by said applicator element support 4 extends.

The angle formed between the direction along which the applicator element support 4 extends in cantilever from a portion of said applicator element support 4 itself and the direction along which an applicator element 5 carried by said applicator element support 4 extends can be greater than 45°, preferably greater than 60°, preferably equal to 90°.

The direction along which an applicator element support 4 extends in cantilever from the envelope 10 is different from the direction along which an applicator element support 4 extends in cantilever from a portion of said applicator element support 4 itself.

The angle formed between the direction along which the applicator element support 4 extends in cantilever from the envelope 10 and the direction along which the applicator element support 4 extends in cantilever from a portion of said applicator element support 4 itself can be greater than 45°, preferably greater than 60°, preferably equal to 90°.

The applicator element supports 4 extend in a tangential plane.

It will however be understood that the applicator element supports 4 can be curved. For example, the applicator element supports 4 can have the same curvature as the envelope 10. Moreover, the applicator element supports 4 can have the same thickness, measured radially, as the envelope 10.

For example, the applicator element supports 4 are not radially protruding from the envelope 10, outward or inward. Alternately or complementarily, the applicator element supports 4 can be protruding and/or recessed radially with respect to the envelope 10.

The applicator element supports 4 can be contained in the convex envelope of the envelope 10. The convex envelope of the envelope 10 is the smallest convex virtual solid containing the envelope 10.

For example, in the case of an envelope 10 in the shape of a revolution cylinder, the applicator element supports 4 are located at a distance from the main axis A which is less than or equal to the outer radius of the envelope 10.

The applicator element supports 4 extend along a tangential and/or axial direction.

In this way, the application of a radial force to the applicator element supports 4, for example due to the contact of the brush 1 with the eyelashes of a user by way of the applicator elements 5, causes a deformation of the applicator element supports 4 along a radial direction. In this way, the following of an eyelash is simplified.

The transverse section of the applicator element supports 4 is contained between 0.25 mm² and 5 mm², preferably between 1 mm² and 2 mm². The transverse section is transverse to the direction along which the applicator element supports 4 extend in cantilever, particularly from the envelope 10.

An example of a surface S over which the transverse section is measured is shown in dotted lines in FIG. 5. It will be understood that the surface S is represented by a rectilinear segment on FIG. 5 since it also extends in a direction out of the plane of FIG. 5.

The width of the applicator element supports 4 is between 0.25 mm and 5 mm, preferably between 1 mm and 3 mm. The width is equivalent to the average width of the surface S measured along a direction in the plane of the applicator element support 4, where applicable curved, and perpendicular to the direction along which the applicator element support 4 extends in cantilever.

In this case, the width of the applicator element supports is measured along the dotted line of the surface S and is measured along the direction of the main axis A.

The applicator element supports 4 may have a taper at the fixed end 4A, where the transverse section of the applicator element supports 4 is minimal. At its minimum, the transverse section of the applicator element supports 4 is between 0.25 mm² and 2 mm². At its minimum, the width of the applicator element supports 4 is between 0.5 mm and 3 mm.

Such a transverse section makes it possible to ensure the flexibility of the applicator element supports 4.

The applicator element supports 4 can also have a flare, the flare being characterized by a position in which the transverse section of the applicator element supports 4 is maximal. At its maximum, the transverse section of the applicator element supports 4 is between 2 mm² and 5 mm². The position at which the transverse section of the flare is measured is located between the fixed end 4A and the free end 4B. For example, the position in which the transverse section of the flare is measured can be closer to the free end 4B than to the fixed end.

At its maximum, the width of the applicator element supports 4 is between 3 mm and 5 mm.

Such a transverse section makes it possible, by comparison with the transverse section of the taper, to locally stiffen the applicator element supports 4, in particular at the applicator element 5 itself.

In this way, the deformation of the applicator element supports 4 is mainly a bend and/or a twist due to the deformation at the taper.

The mechanism of distortion of the applicator element supports 4 is then simplified, which makes it possible to ensure better control of the following of eyelashes when applying formula.

The applicator element supports 4 extend in cantilever from the envelope 10 over a distance D comprise between 0.25 mm and 5 mm. This distance corresponds to the distance measured between the fixed end 4A and the free end 4B. If the applicator element supports 4 are curved or more generally non-planar, the distance D can be the distance, optionally curvilinear, measured along the applicator element supports 4.

The applicator element supports 4 can each have an applicator element 5 at the free end of the applicator element supports 4.

The applicator element supports 4 and the applicator elements 5 can be formed as a single part.

Given that the applicator element supports 4 extend in cantilever, each applicator element support 4 is surrounded by an interstice 6.

The shape of the interstices 6 may match the shape of the applicator element supports 4. In particular, an interstice 6 adjoins an applicator element support 4, and is formed around an applicator element support.

The interstice 6 extends between two interstice ends 6. The interstice 6 extends on either side of the fixed end 4A passing through the free end 4B of one and the same applicator element support 4.

An interstice 6 can surround a single applicator element 4.

It will however be understood that an interstice 6 can also surround several applicator elements 4. For example, as illustrated in FIG. 5, an interstice 6 can extend from the fixed end 4A of a first applicator element support 4 to the fixed end 4A of a second applicator element support 4, surrounding both the first applicator element support 4 and the second applicator element support 4.

A support pattern 3 comprises several applicator element supports 4 having a common interstice 6. For example, FIG. 5 shows a support pattern 3 comprising two applicator element supports 4.

The applicator element supports 4 of one and the same support pattern 3 can have a symmetry, for example a central symmetry as in the embodiment of FIG. 5, an axial symmetry or any other type of geometric invariant, for example rotational.

Moreover, the applicator elements 5 carried by the applicator element supports 4 of one and the same support pattern 3 can also have a symmetry, preferably of the same kind as that of the applicator element supports 4 carrying them.

The interstice 6 of a support pattern 3 can also have a symmetry, for example a central symmetry as in the embodiment of FIG. 5, or else an axial symmetry.

The interstices 6 allow fluid communication between the inside of the hollow envelope 10 and the applicator element supports 4 and the applicator elements 5.

Since the envelope 10 is hollow, the applicator element supports 4 have a radially inward surface contributing to delimiting the inside of the hollow envelope 10 and thus able to come into contact with formula retained in the envelope 10.

The cantilevered structure combined with the deformability of the applicator element supports 4 makes it possible to convey the formula by pumping. A pumping force is exerted by the radially inward surface of the applicator element supports 4 on formula present in the envelope 10 by a to-and-fro movement in a radial direction. The pumping conveys formula from the inside of the hollow envelope 10 to the applicator element supports 4 all the way to the applicator elements 5, where it can be applied to the eyelashes of a user.

Between its two ends, the interstice 6 can extend along a direction that is curved, rectilinear, or a succession of curved and/or rectilinear directions.

Along the interstice 6 between its two ends, the interstice 6 has a width between 0.25 and 1.5 mm, preferably between 0.5 and 1 mm. This width is measured in a direction orthogonal to the direction along which the interstice 6 extends and orthogonal to the radial direction.

The width of the interstice 6 makes it possible to control the quantity of formula that can flow from inside the hollow envelope 10 toward the outside of the envelope 10 through the interstice 6.

The pumping of formula also makes it possible to convey the formula to the applicator elements 5 to be retained there by capillarity between two applicator elements 5 belonging to one and the same support pattern 3, before being applied on the eyelashes.

In this embodiment, a support pattern 3 comprises a pair of applicator element supports 4. In particular, the pair of applicator element supports 4 of one and the same support pattern 3 can be formed of applicator element supports 4 extending in cantilever in one and the same plane and/or along two parallel directions and/or in two circumferences of the same radius.

In particular, here, the applicator element supports 4 of one and the same support pattern 3 extend in cantilever in circumferences of the same radius, i.e. circles belonging to a radial plane, the center of which belongs to the main axis A, and of the same radius. In other words, the applicator element supports 4 of one and the same support pattern 3 extend in cantilever in circles aligned in the direction of the main axis A.

It will be understood that the applicator element supports 4 may extend in the same orientation, i.e. the fixed ends 4A and free ends 4B are aligned in the same orientation, or in the opposite orientation, i.e. the fixed ends 4A and free ends 4B are aligned in the opposite direction (head to foot) as in this embodiment.

Hence, the deformation behavior following the application of a radial force is similar for the applicator element supports 4 of one and the same support pattern, such that the applicator elements 5 of one and the same support pattern 3 can for example contribute to the following of one and the same eyelash or group of eyelashes.

The applicator element supports 4 of one and the same support pattern 3 can extend in one and the same direction and in opposite orientations.

The applicator element supports 4 of one and the same support pattern 3 can for example be invariant by central rotation, for example by an angle of 180°.

The brush 1 can include a plurality of support patterns 3. These support patterns 3 can be patterns of two or more applicator elements 5, in which the applicator element supports 4 have one or more of the features described above.

The brush 1 can have a plurality of support patterns 3 over a contour which is circumferential and/or along the main axis A.

In this summary, the envelope 10 has been presented in the form of a revolution cylinder centered on the main axis A. It will however be understood that the main axis A can be a curved main axis A supporting the envelope 10, itself curved. For example, the main axis A can have a curvature in the order of the curvature of the eyelids of a user, corresponding to the curvature of the arrangement of the eyelashes on the eyelid of a user.

It will be understood that the main axis A can have a piecewise continuous curvature, i.e. the main axis A can comprise mutually discontinuous segments, each of the segments having within itself a continuous curvature, optionally zero (rectilinear segment).

In this summary, the applicator elements 5 are present over the entire circumferential contour of the envelope 10, and on the envelope 10 along the main axis A. It will however be understood that it is possible for certain parts of the envelope 10 not to have any applicator elements 5. For example, one and the same circumferential contour position along the main axis A may not have any applicator elements, in order to allow better control of the application of formula by a user.

The applicator elements 5 are rectilinear here but can also have various shapes, for example with a variable section, a helical shape etc. Moreover, the applicator elements 5 can be of variable length, for example according to their position along the main axis A and/or their position over a circumference.

Such a brush 1 is suitable for manufacturing by a manufacturing process by an additive manufacturing method.

For example, the brush 1 can be manufactured by an additive manufacturing method, for example powder bed fusion, selective laser sintering or multi-jet fusion, for example containing comprising a polymer material from among polyamides, polyolefins, co-polyesters, styrenic polymers, or silicon. It will however be understood that the brush 1 can be made by any combination of manufacturing processes by additive manufacturing methods and associated material having enough resolution for the production of the brush 1 equipped with applicator elements. Such a brush can then be mounted on a support assembled on a stick.

1. A mascara brush comprising a hollow envelope and at least one applicator element support extending from the envelope in cantilever, in which at least one applicator element support carries at least one applicator element at a free end of the at least one applicator element support.

2. The mascara brush as claimed in claim 1, wherein the envelope is made as a single part with the at least one applicator element support.

3. The mascara brush as claimed in claim 1, wherein the at least one applicator element support has a transverse section between 0.25 mm² and 5 mm².

4. The mascara brush as claimed in claim 1, wherein the at least one applicator element support extends in cantilever from the envelope over a distance between 0.25 mm and 5 mm.

5. The mascara brush as claimed in claim 1, wherein the applicator element support is connected to the envelope, forming a taper.

6. The mascara brush as claimed in claim 1, wherein at least one applicator element support extends substantially along a tangential plane of the brush.

7. The mascara brush as claimed in claim 1, comprising at least one support pattern formed by a pair of applicator element supports extending in one and the same direction and in opposite orientations.

8. The mascara brush as claimed in claim 7, wherein the applicator element supports of the support pattern extend substantially along a circumferential direction.

9. The mascara brush as claimed in claim 7, comprising a plurality of support patterns on a circumferential contour of the brush.

10. The method for manufacturing a brush as claimed in claim 1, comprising at least one step of manufacturing by additive method.

11. A mascara applicator comprising a stick and a mascara brush as claimed in claim 1.
